(19) United States
(12) Patent Application Publication
(10) Pub. No.: US 2015/0288287 A1
(43) Pub. Date: Oct. 8, 2015

(54) MODULAR MULTI-LEVEL CONVERTERS

(71) Applicant: AUKLAND UNISERVICES LIMITED, Auckland (NZ)

(72) Inventors: Udaya Kumara Madawala, Stonefields (NZ); Baljit Singh Riar, Royal Oak (NZ)

(21) Appl. No.: 14/430,434

(22) PCT Filed: Sep. 20, 2013
(86) PCT No.: PCT/NZ2013/000173

§ 371 Date: Mar. 23, 2015

(30) Foreign Application Priority Data
Sep. 21, 2012 (NZ) 602575

(51) Int. Cl. H02M 3/335

(52) U.S. Cl. CPC H02M 3/33507

(57) ABSTRACT

This invention relates generally to Modular Multi-level Converters and has particular relevance to a circuit topology for a Modular Multi-level Converter which simplifies the control, reduces power losses and improves the performance in many aspects. There is provided a Modular Multi-level Converter (M2LC) comprising a top circuit arm connected to a bottom circuit arm across a DC supply rail, each arm comprising a number of switch modules having associated capacitances and switches arranged to switch respective voltages into the arm; and voltage correcting means (VCM) arranged to switch a correcting voltage into an arm dependent on a voltage difference between the top and bottom arms or a circulating current in the arms.

### FIELD OF THE INVENTION

This invention relates generally to Modular Multi-level Converters and has particular relevance to a circuit topology for a Modular Multi-level Converter which simplifies the control, reduces power losses and improves the performance in many aspects.

### BACKGROUND

Modular Multi-Level Converters (M2LC), as shown in FIG. 1(a), have recently become popular in both high and medium power applications. They provide a number of advantages over other available multi-level converter topologies, such as Neutral Point Clamped Voltage Source Converter (NPC VSC), Flying Capacitor Voltage Source Converter (FC VSC) and Series Connected H-Bridge Voltage Source Converter (SCHB VSC). Some of the features of M2LC are: simple scaling of the number of output voltage levels by a linear addition of identical modules, as shown in FIG. 1(b); capacitor free dc-bus; continuous arm currents; reduced voltage rating of the switches, and; redundant switching operations.

These features of the M2LC topology make it suitable for various applications such as high-voltage direct current (HVDC) transmission, and high power motor drives, traction motors, static synchronous compensators (STATCOM) and as a general grid connected converter.

In general, load currents of M2LC are controlled taking into account capacitor voltages and circulating currents so as to ensure stable operation of the converter. The importance of balancing the capacitor voltages around their nominal value has already been acknowledged in literature. Circulating currents or balancing currents, i_{cir,r}, r∈{a, b, c}, are inherent to the M2LC topology and manifest from variation in the capacitor voltages, which are connected in parallel to the dc-bus. If these currents are not controlled or minimized then the arm current, rating of the switches and conduction losses will all increase.

There is, therefore, a need to minimize the variation in the capacitor voltages to maintain the stability of the converter and minimize circulating currents and, hence, the power losses in the converter. Furthermore, it is highly desirable to control M2LC, being a multi-level topology, with Stair-Case Modulation (SCM), Optimized Pulse Patterns (OPPs) and Optimal Pulse Width Modulation (OPWM), to achieve a low switching frequency for a given distortion of the load currents. However, PWM schemes have been extensively used in M2LCs to minimize circulating currents but at the expense of switching losses. It is inherent with these control schemes that the output voltage of the converter will be below its maximum possible value, which leads to a reduction in the output power.

One approach is to increase the switching frequency of the switch modules, however this is difficult to control. In another approach a transformer is used in the two arms of a phase leg, instead of the two inductors of FIG. 1(a). The secondary is then coupled to the load. However, this arrangement is bulky and expensive.

The reference to any prior art in the specification is not, and should not be taken as, an acknowledgement or any form of suggestion that the prior art forms part of the common general knowledge in any country.

### SUMMARY

It is an object of the present invention to provide a Modular Multi-level Converter, or method for operating such a converter, which will overcome or at least ameliorate one or more of the disadvantages of existing constructions or methods; or provide the public with a useful choice.

Accordingly in one aspect the invention broadly provides a Modular Multi-level Converter having a voltage correction means operable to correct the capacitor voltage of one or more switch modules of the converter.

Preferably the correction means is such that the capacitor voltages are as close as possible to their nominal values.

In another aspect the invention broadly provides a Modular Multi-level Converter having a plurality of arms connected in parallel with a power supply, each arm having a plurality of switch modules, each switch module having an associated capacitor, and at least one arm being associated with a voltage correction means to correct the voltage of one or more of the capacitors in that arm.

Preferably the voltage correction means correct the total voltage that is injected by the module capacitors in an arm.

Preferably the voltage correction means is associated with each arm.

In one embodiment the voltage correction means comprises a module.

In one embodiment the voltage correction means comprises a module associated with each arm.

Preferably the voltage correction module comprises a plurality of switches and an associated capacitor.

In a further aspect the invention broadly provides a method of correcting a capacitor voltage of a Modular Multi-level Converter switch module, the method including the steps of determining a voltage difference that requires correction, and applying an equal and opposite voltage to thereby provide a correction.

In a further aspect the invention broadly provides methods to facilitate independent (or decoupled) control of load currents and capacitor voltage of the or each module.

In one embodiment the method includes providing the correction using a voltage correction module.

In one embodiment the voltage correction means (VCM) comprises a module associated with each arm or shared amongst top, bottom or a combination of top or/and bottom arms in an appropriate way.

Preferably the voltage correction module comprises a plurality of switches and an associated capacitor.

In a further aspect there is provided a Modular Multi-Level Converter (M2LC) comprising a top circuit arm connected to a bottom circuit arm across a DC supply rail, each arm comprising one or more switch modules having associated capacitances and switches arranged to switch respective voltages into the arm; and voltage correcting means (VCM) arranged to switch a correcting voltage into an arm.

The correcting voltage may be used to address imbalances in the modular multi-level converter (M2LC) such as circulating currents and/or voltage differences across the capacitances associated with the top and bottom circuit arm. This may be used to correct differences in the actual voltage switched in by the switch modules compared with their nominal or intended values. Such differences can occur in practice due to the use of capacitances which discharge and hence their voltages reducing over the period over which they are switched in for example.

A VCM may be provided for each switch module, all the switch modules in the arm or various combinations. The VCM may be a separate circuit arrangement from the switch modules, allowing less voltage to be switched across it's capacitor compared with the capacitors of the switch modules, thereby allowing a reduced rating and cheaper cost. Furthermore, the use of a separate VCM enables simpler control of the switch modules which no longer need to be controlled in order to correct for variations in their nominal voltages when switched in. This can allow the switch modules to operate at lower frequencies.

In an embodiment, the correcting voltage is dependent on a difference between the nominal respective voltage switched in by the or each switch module and an actual voltage across the or each switch module in use. This difference can be determined by directly measuring voltages of parts or all of the arms, using arm current measurement, or predictions of the actual voltage across the switch module in use, for example based on the total current draw from the arms to the load.

In an embodiment, separate control signals are used to switch the correcting voltage and the switch modules. This simplifies design and operation of the M2LC, and in particular control of the switch modules.

In an embodiment, the correcting voltage is sufficient to substantially cancel the voltage difference or circulating current. In case of a voltage difference, the correcting voltage is substantially equal and opposite to the voltage difference.

In an embodiment the voltage correcting means (VCM) has an associated capacitance and switch arranged to switch the capacitance into a respective arm in order to provide the correcting voltage. A VCM may be provided in each arm. The capacitance used by the VCM may be shared between arms. In an embodiment the VCM comprises first and second switch pairs each having a top and bottom switch with a common connection connected to the circuit arm such that the VCM is connected into the arm in series, with the other sides of the switches being connected across the associated capacitance and with switches controlled in order to generate the correcting voltage.

Such arrangements provide for relatively low capacitance voltages compared with the voltage across the arm which allows lower cost capacitance and other VCM components to be used. Alternative VCM arrangements can also be employed, including those described herein.

In an embodiment, an M2LC comprises three phase legs each including a top and a bottom circuit arm, each arm having a VCM. A capacitance associated with a VCM may be shared with one or more other VCM, for example across the other two phases in the corresponding top or bottom circuit arm, with the other arm of the same phase, or in combination with all six VCM across the two arms of each phase.

In an embodiment the M2LC further comprises voltage and/or current determining means further arranged to determine a voltage and/or current associated with the, each or a combination of switch modules, where the VCM is arranged to generate a VCM reference voltage dependent on the determined voltages and/or currents, and further arranged to control a capacitance voltage across the capacitance associated with the VCM dependent on the VCM reference voltage.

In an embodiment the VCM reference voltage is dependent on an integrated difference between a signal derived from the determined arm currents and a reference circulating current. The signal may be derived from an average of the determined arm currents. The signal may be derived from the phase and/or quadrature components of the determined arm currents. The phase and quadrature components may be determined with respect to a harmonic frequency of the circulating currents in the arm circuits.

In an alternative embodiment, the VCM reference voltage is dependent on a difference between the DC rail voltage and the determined arm voltages.

Such arrangements allow the provision of control signals to the VCM switches in order to control the voltage across the VCM capacitors to be dependent on a voltage difference between the top and bottom arms and/or a current in the arms.

In another embodiment, the M2LC further comprises capacitance voltage determining means arranged to determine a voltage across the capacitance associated with the VCM, the VCM arranged to control the capacitance voltage dependent on a difference between the determined capacitance voltage and a reference capacitance voltage. This reference capacitance voltage may be the nominal voltage of the capacitance. In an embodiment the VCM is arranged to control the capacitance voltage dependent on an integrated difference between the determined capacitance voltage and the reference capacitance voltage.

Such arrangements allow control of the capacitance voltage in order to reduce the nominal voltage of the capacitor required and hence its cost.

In a further aspect there is provided a voltage correcting means (VCM) for use in a Modular Multi-level Converter (M2LC) having a top circuit arm connected to a bottom circuit arm across a DC supply rail, each arm comprising one or more switch modules having associated capacitances and switches arranged to switch respective voltages into the arm; the VCM arranged to switch a correcting voltage into an arm.

In an embodiment the correction voltage is arranged to correct for a voltage difference between a nominal respective voltage switched in by the or each switch module and an actual respective voltage switched in by the or each switch module in use.

In a further aspect there is provided a method of operating a modular Multi-level Converter (M2LC) having a top circuit arm connected to a bottom circuit arm across a DC supply rail, each arm comprising one or more switch modules having associated capacitances and switches arranged to switch respective voltages into the arm; the method comprising switching a correcting voltage into an arm in order to correct the or each respective voltage switched in by the or each switch module.

In an embodiment the correction voltage is dependent on a difference between a nominal respective voltage switched in by the or each switch module and an actual voltage across the or each switch module in use.

In an embodiment the VCM is controlled independently of the switch modules. For example separate control circuitry providing separate control signals respectively to the switch modules and VCM are provided. This reduces the complexity which might otherwise be associated with controlling the switch modules in order to reduce voltage differences and circulating currents. The correcting voltage may be sufficient to substantially cancel the voltage difference between the top and bottom circuit arms or the circulating current in the arms.

In an embodiment the M2LC has a voltage correcting means (VCM) with an associated capacitor and switch, and the method of operating the M2LC further comprises switching the associated capacitor into a respective circuit arm in order to provide the correcting voltage. The associated capacitor may be one or more discrete capacitors or equivalent capacitance means, and the associated capacitor may be shared with other VCM with appropriate modifications to the switching of the respective VCM.

In an embodiment the method determines a voltage or current associated with the, each or a combination of switch modules, generates a VCM reference voltage dependent on the determined voltages and/or currents, and controls a capacitance voltage across the capacitor associated with the VCM dependent on the VCM reference voltage.

In an embodiment, the VCM reference voltage is dependent on an integrated difference between a signal drive from the determined arm currents and reference circulating current. The signal may be derived from an average of the determined arm current. The signal may be derived from the phase and/or quadrature components of the determined arm current. The phase and quadrature components may be determined with respect to a harmonic frequency of the circulating current in the arm circuit.

In an alternative embodiment, the VCM reference voltage is dependent on a difference between the DC rail voltage and the determined arm voltages.

In an embodiment, the method further comprises determining a voltage across the capacitance associated with the VCM, and controlling the capacitance dependant on a difference between the determined capacitance voltage and a reference capacitance voltage. This reference capacitance voltage may be the nominal voltage of the capacitance. The method may be arranged to control the capacitance voltage dependent on an integrated difference between the determined capacitance voltage and the reference capacitance voltage.

In another aspect there is provided a computer programme arranged to perform any of the defined or described methods of operating an M2LC. The computer programme may be embodied in a computer programme product, including a non-transitory product such as a CD rom, electronic memory or other storage means, and may also be embodied in a transitory product such as a signal, for example, an electromagnetic signal for an Internet download.

In another aspect there is provided a modular multi-level converter comprising a top arm connected to a bottom arm across a DC supply, the connection point providing an AC supply, each arm comprising a number of switch modules having associated capacitors and switches arranged to switch the capacitances into the arm according to respective control signals; and a voltage correcting module or Voltage Correcting Means having an associated capacitor and switch arranged to switch the capacitance into an arm according to an independent control signal, and dependent on a voltage difference between the top and bottom arms or a circulating current in the arms. In an embodiment the voltage correcting module or Voltage Correcting Means is arranged such that the capacitor voltages are as close as possible to their nominal value.

In another aspect, there is provided a multilevel converter with a first type of module operable to switch in voltages in order to generate an AC output, and a second type of module operable to introduce adjustment voltages. The second type of module may be separately controllable from the first type of module, may have smaller capacitances and/or apply lower voltages than the first type of module.

The invention may be said to broadly consist in the parts, elements and features referred to or indicated in the specification of the application, individually or collectively, in any or all combinations of two or more said parts, elements or features, and where specific integers are mentioned herein which have known equivalents in the art to which the invention relates, such known equivalents are deemed to be incorporated herein as if individually set forth.

Further aspects of the invention, which should be considered in all its novel aspects, will become apparent from the following description given by way of example of possible embodiments of the invention.

### DRAWING DESCRIPTION

FIG. 1(a) shows a circuit schematic for a conventional Modular Multi-level Converter;

FIG. 1(b) shows a circuit schematic for a module for a converter according to FIG. 1(a);

FIG. 2(a) shows a circuit schematic for a proposed novel topology for a modular multi-level converter (M2LC);

FIG. 2(b) shows a circuit schematic for a novel voltage correction module for the M2LC according to FIG. 2(a);

FIG. 2(c) shows a circuit schematic for an alternative voltage correction module for the M2LC of FIG. 2(a);

FIG. 3 shows an equivalent circuit for the converter of FIG. 1(a);

FIG. 4 shows an equivalent circuit for the converter of FIG. 2(a);

FIG. 5 shows a control diagram schematic for coupled control of a VCM module according to FIG. 2(b);

FIG. 6 shows a control diagram schematic for phase-leg control of a VCM module according to FIG. 2(b);

FIG. 7 shows a control diagram schematic for coupled phase-leg control of a VCM module according to FIG. 2(b);

FIGS. 8(a), 8(b) and 8(c) show waveforms of simulated load currents with M2LC-VCM/SCM, M2LC-VCM/PWM and M2LC/PWM, respectively;

FIGS. 9(a), 9(b) and 9(c) show waveforms of simulated arm currents in phase ‘a’ with M2LC-VCM/SCM, M2LC-VCM/PWM and M2LC/PWM respectively;

FIGS. 10(a), 10(b) and 10(c) show waveforms of simulated circulating currents with M2LC-VCM/SCM, M2LC-VCM/PWM and M2LC/PWM respectively;

FIGS. 11(a), 11(b) and 11(c) show waveforms of simulated capacitor voltages in phase ‘a’ with M2LC-VCM/SCM, M2LC-VCM/PWM and M2LC/PWM respectively;

FIG. 12 shows waveforms of simulated converter output voltage in phase ‘a’ with M2LC-VCM/SCM;

FIG. 13 shows waveforms of simulated converter output voltage in phase ‘a’ with M2LC-VCM/PWM;

FIG. 14 shows waveforms of simulated converter output voltage in phase ‘a’ with M2LC/PWM;

FIG. 15 shows waveforms of simulated VCM capacitor voltages in phase-leg of phase ‘a’;

FIG. 16(a) shows waveforms of simulated output voltage of the top VCM in phase ‘a’;

FIG. 16(b) shows plots of simulated output voltage of the bottom VCM in phase ‘a’;

FIG. 17(a) shows a circuit schematic of an alternative embodiments referred to as a M2LC-VCM topology;

FIG. 17(b) shows a circuit schematic of a voltage correcting module or Voltage Correcting Mean(VCM) for the FIG. 17(a) topology.

FIG. 18(a) shows a circuit schematic of another alternative embodiments referred to as a M2LC-VCM topology;

FIG. 18(b) shows a circuit schematic of a voltage correcting module or Voltage Correcting Mean(VCM) for the FIG. 18(a) topology.

FIG. 19(a) shows a circuit schematic of yet another alternative embodiments referred to as a M2LC-VCM topology;

FIG. 19(b) shows a circuit schematic of a voltage correcting module or Voltage Correcting Means (VCM) for the FIG. 19(a) topology.

FIG. 20 shows a different circuit schematic for a proposed novel topology that is suitable for single phase applications;

### DESCRIPTION OF EMBODIMENTS

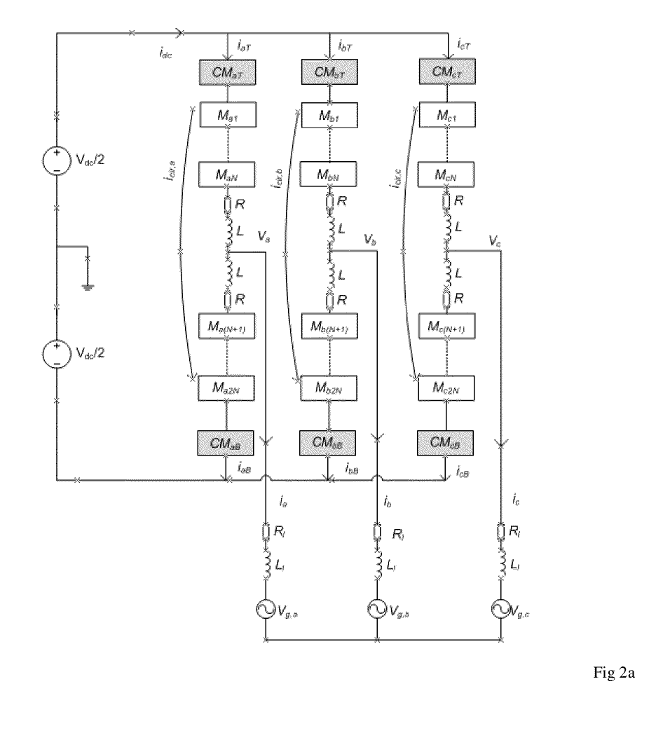

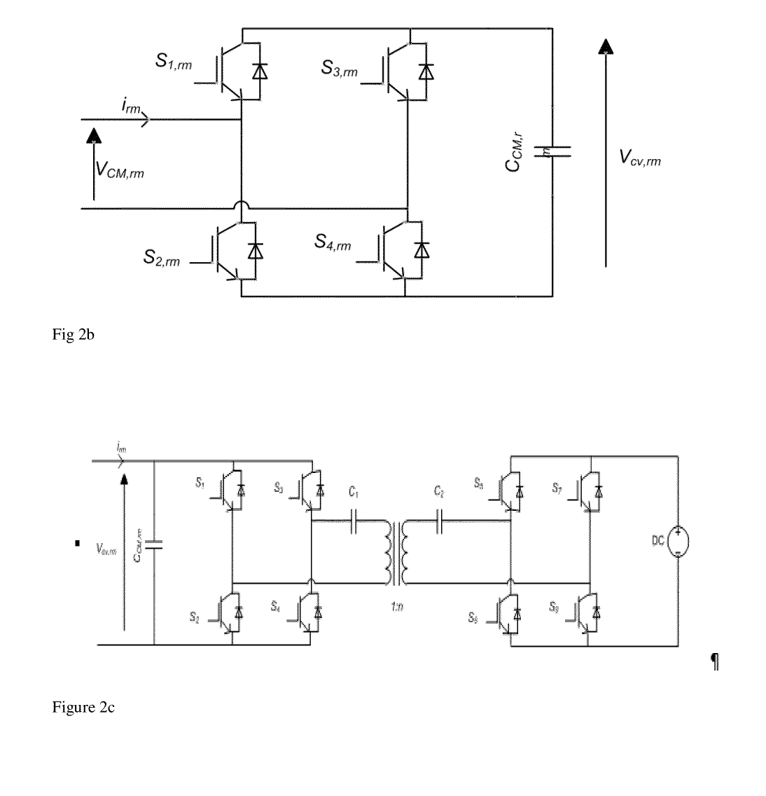

A novel topology for a Modular Multi-Level Converter with Voltage Correcting Modules (M2LC-VCMs), which overcomes or at least ameliorates disadvantages of the conventional M2LC, is shown in FIG. 2(a). In this embodiment, variation in the capacitor voltages and circulating currents are reduced by employing a Voltage Correcting Module or Voltage Correcting Means (VCM), as shown in FIG. 2(b), in each arm of the proposed topology and is represented as CMᵣₘ, r∈{a, b, c}, m∈{T,B} in FIG. 2(a). A VCM is connected in series with one or more switch modules in a respective top or bottom arm circuit. In the embodiment, the VCM is an H-bridge/full-bridge module that is employed to minimize the difference in voltages of top and bottom circuit arms and the dc-bus or DC supply rail. VCM does not require any external power source and the voltage across its capacitor is only a fraction of the voltage across the M2LC's module capacitor. Hence, voltage rating of the VCM switches, S_{1,rm}-S_{4,rm}, is also a fraction of that required for the M2LC's module switches.

The VCM of FIG. 2(b) utilises two switch pairs connected in parallel with an associated capacitor. The common connection of each switch pair is connected to the top or bottom circuit arm such that the VCM is connected into the arm in series with the switch modules. The other sides of the switches are connected across the associated capacitor. The switches are controlled in order to generate the connecting voltage as will be described in more detail below.

FIG. 2(c) shows an alternative arrangement voltage correcting module or means (VCM), and which can be employed in each arm of the modified M2LC of FIG. 2(a). In this arrangement the capacitor Ccm,rm is connected in series with the M2LC modules. The capacitor voltage V_{cv,rm} is controlled at its nominal value of V_{cv,nom}, as follows:

V_{CV,rm}=V_{CV,nom}±ΔV, and ΔV<V_{CV,nom}

Voltage discrepancies in a phase-leg or circulating currents are compensated by inserting either a positive +ΔV and negative −ΔV voltage in the arm of the converter. The voltage to be inserted, ΔV, and nominal voltage, V_{CV,nom}, can be controlled by using a H-bridge circuit as shown in FIG. 2(c).

The VCMs are driven with a carrier based PWM scheme to achieve a high dynamic performance. As VCM is a low-power rated module, its operation with a PWM scheme does not increase overall losses in the converter in comparison to the conventional M2LC topology. Some of the other benefits of the M2LC-VCM are listed below:

1) Minimization of circulating currents, leading to lower arm currents.

2) Significant reduction in power losses, both conduction and switching, leading to saving in the thermal design, related to heat-sinking or cooling requirements.

3) For a given switching frequency, significant reduction in Total Harmonic Distortion (THD) of the load currents.

4) For a given variation in the capacitor voltages, substantial reduction in the capacitor size in comparison to the existing M2LC topology or, equivalently, reduction in the energy that is stored in the converter.

5) Reduced footprint that is mainly determined by the capacitor size in each module.

6) The maximum output voltage is not compromised by the proposed topology.

7) Simplified control of the M2LC with an independent control of the VCMs. In addition, operation of the VCM is unaffected by the number of modules in an arm. The proposed topology may also be applicable to M2LCs with full-bridge modules, which essentially require accurate balancing of module capacitor voltages to ensure proper functioning.

Furthermore, there are other variations of the proposed topology that are set forth further in the document.

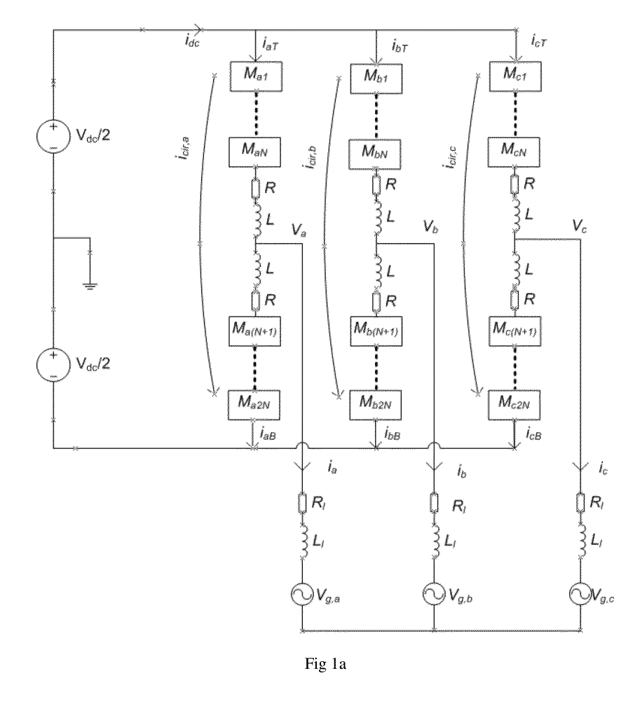

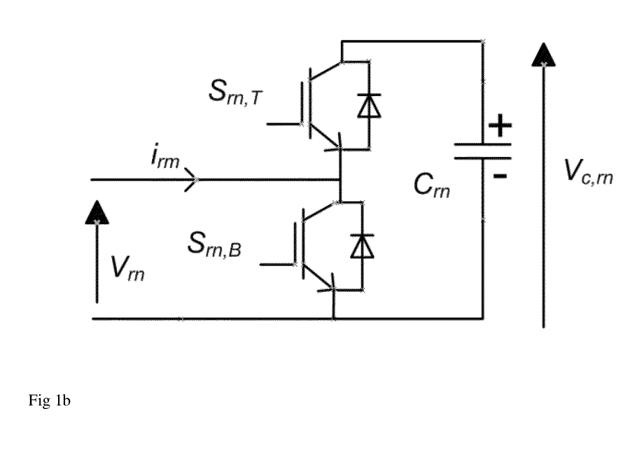

For example, a grid connected M2LC of the prior art is shown in FIG. 1(a). Each phase-leg of the converter is divided into two halves, called arms. Each arm consists of N modules, which are represented as Mₘ, r∈{a, b, c}, n∈{1, 2, . . . , 2N}, a resistor, R, that models conduction losses and an arm inductor, L. A typical switch module is a half-bridge, and acts like a chopper cell with a capacitor, Cₘ, which is connected to its terminals as shown in FIG. 1(b). The individual module has two switching states Uₘ∈{0, 1}, where 1 means the capacitor is connected in the circuit, i.e. switch S_{m,T} is turned on and vice-versa. The turn on operation of the switches in a module is complementary to one another. The output I of the converter is connected to a load, which consists of an inductor L_{I} in series with a resistor R_{I} and a grid voltage V_{g,r}. The voltage produced in the middle of any phase leg of the converter, Vᵣ, is measured in this document with respect to the mid-point of the dc-bus or supply rail, which is used a reference voltage throughout this document. Physically, the mid-point might not be accessible and in this document, the mid-point is mainly used to demonstrate that converter produces N+1 voltage levels at its output terminals. Further details on the operating principle and characteristics of the M2LC can be found in the prior art.

As mentioned earlier, the circulating currents are generated by the difference in the voltages of capacitors (top and bottom arms) and the dc-bus. The current through each arm, iᵣₘ, r∈{a, b, c}, m ∈{T,B}, can be split into three components: (1) half of the load current, iᵣ/2, (2) a third of the dc-bus current, i_{do}/3 and (3) the circulating currents, i_{cir,r}. For a given phase-leg, components (2) and (3) are referred to as dc-circulating currents, i_{dc-cir,r}, in this document. The dc-circulating and the circulating currents in phases a, b and c are given by

$$\begin{matrix}{i}_{dc - cir , r} ( t ) = \frac{{i}_{rT}}{2} ( t ) + \frac{{i}_{rB}}{2} ( t ) , r ∈ \{ a , b , c \} & ( 1 ) \\ {i}_{cir , r} ( t ) = \frac{{i}_{rT}}{2} ( t ) + \frac{{i}_{rB}}{2} ( t ) - \frac{{i}_{dc}}{3} , r ∈ \{ a , b , c \} & ( 2 )\end{matrix}$$

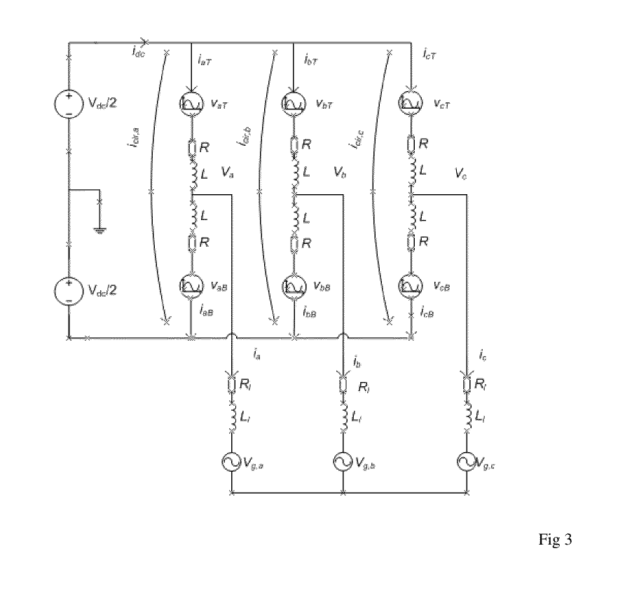

To analyse the interdependence between circulating currents and switch modules' capacitor voltages, it is assumed that the number of modules, N, in an arm is sufficiently large. Thus, each arm of the M2LC can be represented as a Controllable Voltage Source (CVS), as given by (3) and (4), with Vᵣₘ∈[0, V_{dc}] and the equivalent circuit of the M2LC is shown in FIG. 3.

V_{rT}(t)=Σₙ₌₁^{N}uᵣₙV_{c,rn}(t), r∈{a, b, c} (3)

V_{rB}(t)=Σ_{n=N+1}^{2N}uᵣₙV_{c,rn}(t), r∈{a, b, c} (4)

Each converter output voltage in FIG. 3 is defined as follows:

$${V}_{r} ( t ) = \frac{{V}_{rB} ( t ) - {v}_{rT} ( t )}{2} + \frac{R}{2} ( {i}_{rB} ( t ) - {i}_{rT} ( t ) ) + \frac{L}{2} ( \frac{{di}_{rB} ( t )}{dt} - \frac{{di}_{rT} ( t )}{dt} ) , r ∈ \{ a , b , c \} \qquad ( 5 )$$

The relationship between the CVS, and the dc-bus can be expressed as follows:

$${V}_{dc} - {V}_{rB} ( t ) - {V}_{rT} ( t ) = R ( {i}_{rB} ( t ) + {i}_{rT} ( t ) ) + L ( \frac{{di}_{rB} ( rt )}{dt} + \frac{{di}_{rT} ( t )}{dt} ) , r ∈ \{ a , b , c \} \qquad ( 6 )$$

Substituting (2) in (6) and after mathematical manipulations, the voltage difference (or imbalance) in a phase-leg can be expressed by

$${V}_{dc} - {V}_{rB} ( t ) - {V}_{rT} ( t ) = 2 {Ri}_{cir , r} ( t ) + 2 L \frac{{di}_{circ , r} ( t )}{dt} + \frac{2}{3} {Ri}_{dc} , r ∈ \{ a , b , c \} \qquad ( 7 )$$

Equation (7) is derived with the assumption that dc-bus current, i_{dc}, is constant, and indicates the voltage difference in a phase-leg is a function of circulating currents. The voltage difference is further exacerbates with control algorithms that yield a limited number of switching pulses and PWM schemes with low switching frequency as they cannot minimize the voltage difference. Circulating currents can also be decreased by increasing the arm inductance or, equivalently, increasing the characteristic impedance, Z_{cir}, as seen by the circulating currents. The circulating currents can be represented in a way that they consist of infinite number of harmonics. Therefore, there will be characteristic impedance for each harmonic Z_{cir,h}, h∈[0, ∞], and can be defined as follows:

$${Z}_{cir , h} = 2 R + \frac{1}{j {ω}_{h}} ( \frac{1}{{C}_{T}} + \frac{1}{{C}_{B}} ) + j {ω}_{h} 2 L , h ∈ [ 0 , ∞ ] , \qquad ( 8 )$$

where, C_{T} and C_{B} are the equivalent capacitance in the top and bottom arm, respectively. Equation (8) can also be rewritten as

$${Z}_{cir , h} = 2 R + \frac{j ( {ω}_{h}^{2} 2 {LC}_{T} {C}_{B} - {C}_{B} - {C}_{T} )}{{ω}_{h} {C}_{T} {C}_{B}} \qquad ( 9 )$$

It is evident from (9) that the characteristic impedance is a function of the arm inductance and latter can be increased to reduce the circulating currents. However, an increase in the imaginary part of Z_{cir,h} relative to the arm resistance, R, reduces the damping of the circulating currents. During the transient state, such as sudden change of the load current, there will be large oscillations in the circulating currents and the capacitor voltages. Furthermore, with large arm inductance, a voltage drop across it cannot be neglected, as evident from (5) and it affects the output voltage. A large value of L means bulky arm inductors which in turn increase the footprint of the converter.

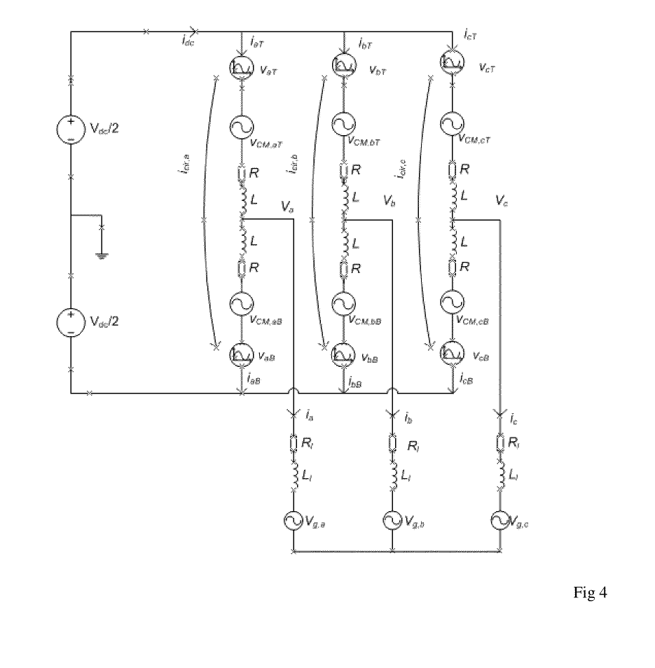

In developing a solution to the problems, related to circulating currents, a logical approach is to make left hand side of (7) equal to zero. In addition, such a solution should not affect the dynamic behaviour of the converter output voltages or the load currents. Hence, M2LC with a Voltage Correcting Module (M2LC-VCM) is proposed and an equivalent circuit of M2LC-VCM is shown in FIG. 4.

In an embodiment each arm has its dedicated VCM, which is explicitly used for minimizing the difference in the voltages of the top and bottom circuit arms and the dc-bus or supply rail. Arm currents and voltage across the VCM capacitors can be related as follows:

$$\begin{matrix}\frac{{V}_{dc}}{2} - {V}_{rT} ( t ) - {V}_{CM , rT} ( t ) - {V}_{r} ( t ) = {Ri}_{rT} ( t ) + L \frac{{di}_{rT} ( t )}{dt} , r ∈ \{ a , b , c \} & ( 10 ) \\ \frac{{V}_{dc}}{2} - {V}_{rB} ( t ) - {V}_{CM , rB} ( t ) + {V}_{r} ( t ) = {Ri}_{rB} ( t ) + L \frac{{di}_{rB} ( t )}{dt} , r ∈ \{ a , b , c \} & ( 11 )\end{matrix}$$

Adding (10) and (11) gives dc-circulating currents

$${V}_{dc} - {V}_{rB} ( t ) - {V}_{rT} ( t ) ] - [ {V}_{CM , rT} ( t ) + {V}_{CM , rB} ( t ) ] = R ( {i}_{rB} ( t ) + {i}_{rT} ( t ) ) + L ( \frac{{di}_{rB} ( t )}{dt} + \frac{{di}_{rB} ( t )}{dt} ) , r ∈ \{ a , b , c \} \qquad ( 12 )$$

The left hand side of (12) shows that dc-circulating currents or, hence the circulating currents, can be eliminated or significantly reduced by adding an equal and opposite voltage to the voltage difference in a phase-leg. Subtracting (10) from (11) gives modified converter output voltages

$${V}_{r} ( t ) = \frac{{V}_{rB} ( t ) - {V}_{rT} ( t )}{2} + \frac{[ {V}_{CM , rB} ( t ) - {V}_{CM , rT} ( t ) ]}{2} + \frac{R}{2} ( {i}_{rB} ( t ) - {i}_{rT} ( t ) ) + \frac{L}{2} ( \frac{{di}_{rB} ( t )}{dt} - \frac{{di}_{rT} ( t )}{dt} ) , r ∈ \{ a , b , c \} \qquad ( 13 )$$

It is evident from (13) that the converter output voltage, Vᵣ, can be increased by utilizing the voltage difference of the VCMs,{V_{CM,rB}(t)−V_{CM,rT}(t)}/2. However, in a proposed solution, V_{CM,rB}(t) and V_{CM,rT}(t) are set to be equal. Therefore, voltage differences in (12) are corrected without affecting the converter output voltages.

VCM control: Some control strategies that can be employed in the Voltage Correcting Modules are described below:

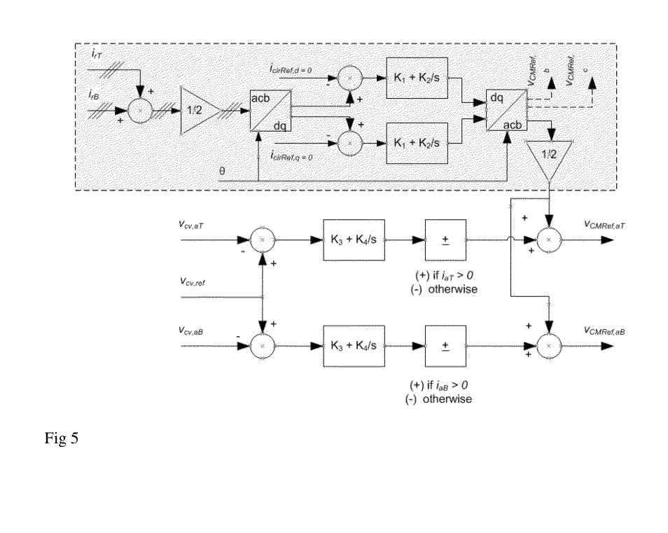

1) Coupled controller: A first scheme utilizes the symmetry of the three-phase converter to control Voltage Correcting Modules and is presented in FIG. 5. The control scheme has two parts, which are required to minimize the circulating currents and balance the capacitor voltage of each VCM. Firstly, circulating currents in acb frame are transformed into dq or in-phase and quadrature quantities, followed by comparison with their reference values and, finally, Proportional-Integral (PI) controllers are employed to generate VCM referenc voltages, V_{CMRef,r} in each phase-leg. As explained above, the circulating currents can be reduced by injecting voltages V_{CM,rT} and V_{CM,rB} in such a way that makes the left hand side of (12) equal to zero and without affecting the output voltage (13). Therefore, V_{CMRef,r} is equally divided and added to voltage reference of the top and bottom VCMs of a phase-leg.

In other words currents associated with the top and bottom circuit arms are determined by a suitable current measurement means. Typical currents measured are the total top and bottom circuit currents i_{rT} and i_{rB}. These are then averaged and split into in-phase and quadrature components, compared with reference circulating current values, with the difference or error being integrated, the recombined signal providing or contributing to a VCM reference voltage for use in controlling the capacitance voltage associated with the VCM.

A second part of the control scheme maintains the voltage of the VCM capacitors, V_{CV,rm}, at their nominal value. The bottom two loops of the control scheme, shown for phase ‘a’, use PI controllers to control the dc average of the VCM capacitor voltages and are based on the polarity of the arm currents, iᵣₘ.

The output signal may provide the VCM reference voltage or may be combined with the signal from the first part of the control scheme to generate this. Finally, voltage references, V_{CMRef,rm}, are compared against carrier waveforms to generate pulse patterns for switches S_{1,rm}-S_{4,rm}.

In this scheme, θ is tuned to a particular harmonic of the circulating currents and hence, has a limitation of minimizing that harmonic current. However, for a fixed output frequency, circulating currents can be significantly reduced as long as θ is tuned to a dominant harmonic of the circulating currents.

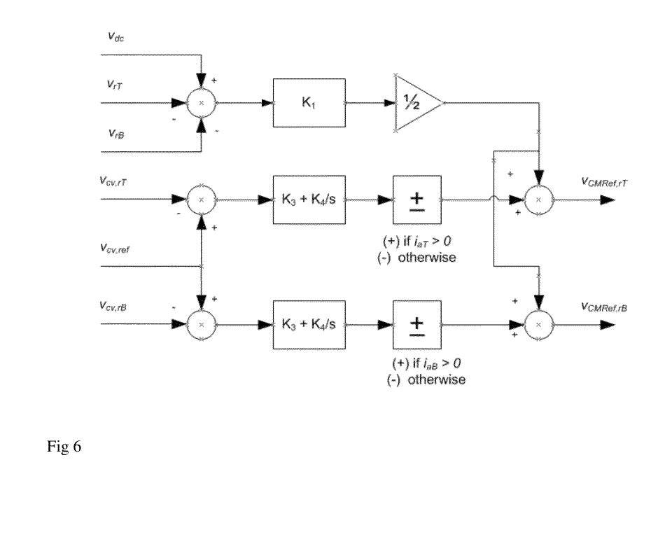

2) Phase-leg VCM controller: Another control scheme that is based on a difference in the determined voltages of top and bottom arm and the dc supply rail is presented in FIG. 6. The top loop of the control scheme, as shown in FIG. 6, employs a proportional controller to generate a voltage reference for the VCMs in a phase-leg. As explained above, the output of proportional controller is then equally divided and added to the voltage reference of the top and bottom VCMs. Bottom two loops are identical to the coupled controller and are needed to control the average voltage of the VCM capacitors.

For a given output frequency and with this control scheme, circulating currents might not be minimized to the same extent as with the coupled controller, because of the asymmetrical nature of the control scheme. However, it can be proven beneficial for variable output frequency operations. As an example, consider that M2LC is driving a Variable Frequency Drive (VFD). Then it becomes difficult to determine a dominant harmonic in the circulating currents, as the harmonic depends on the output frequency. Since, the coupled controller is tuned to a particular harmonic of the circulating currents, in case of the VFDs, it becomes difficult to detect and minimize the dominant harmonic of the circulating currents. In contrast, the phase-leg VCM controller works independent of the circulating currents and minimizes the difference in the voltages of the top and bottom arms and the dc-bus.

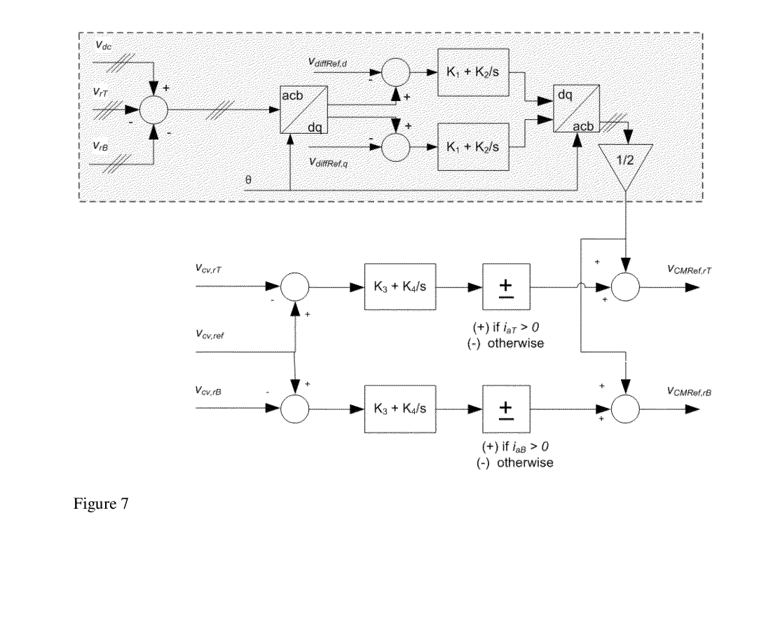

3) Coupled Phase-leg VCM controller: The Phase-leg VCM controller can also be further modified to utilize the symmetry of arm voltages in three phase-legs to derive the Voltage Correcting Modules. The modified control scheme is shown in FIG. 7. In this scheme, difference in the voltages of top and bottom arm and the dc-bus, which are in acb frame, are transformed into dq quantities, followed by comparison with their reference values and, finally, Proportional-Integral (PI) controllers are employed to generate voltage references in each phase-leg. As explained above, the output of PI controller is then equally divided and added to the voltage reference of the top and bottom VCMs. The bottom two loops are identical to the coupled controller and are needed to control the average voltage of the VCM capacitors.

The VCM controllers operate independent of the M2LC control algorithm. This allows simplification of the switch module control whilst reducing circulating currents and voltage differences between the arms. This may lead to lower nominal value capacitances for the switch modules and hence reduce their costs.

Reference Selection of the VCM Capacitor Voltage

Voltage across the VCM capacitors determines the losses in the converter, reduction in the circulating currents and voltage variation of the M2LC module capacitors. A cost function, C_{VCV,ref}, is formulated to determine a voltage reference, V_{CV,ref}, of the VCM capacitors, and is presented in (14).

$${C}_{Vcv , ref} = {λ}_{1} ∥ {V}_{Diff} {∥}_{2}^{2} + {λ}_{2} ∥ {V}_{CMDiff} {∥}_{2}^{2} + {λ}_{3} ∥ {i}_{dc - cir} {∥}_{2}^{2} + {λ}_{4} {P}_{loss} \\ Where , \\ {V}_{Diff} = [ \begin{matrix}{V}_{c , a 1 - \frac{{V}_{dc}}{N}} \\ {V}_{c , a 2 - \frac{{V}_{dc}}{N}} \\ ⋮ \\ {V}_{c , c 2 N - \frac{{V}_{dc}}{N}}\end{matrix} ] , {V}_{CMDiff} = [ \begin{matrix}{V}_{CV , aT} - {V}_{cv , ref} \\ {V}_{CV , aB} - {V}_{cv , ref} \\ ⋮ \\ {V}_{CV , cB} - {V}_{cv , ref}\end{matrix} ] , {i}_{dc - cir} = [ \begin{matrix}\frac{{i}_{aT} + {i}_{aB}}{2} \\ \frac{{i}_{bT} + {i}_{bB}}{2} \\ \frac{{i}_{cT} + {i}_{cB}}{2}\end{matrix} ] \qquad ( 14 )$$

Here, λ₁, λ₂, λ₃ and λ₄ are the weighting coefficients and ∥·∥is 2-norm. The first term in the cost function penalizes the variation of the M2LC capacitor voltages. The second term is used to minimize variation of the VCMs capacitor voltages. The third term is a measure of the circulating currents in the M2LC. The last term is used to minimize the total power loss in the converter. A heuristic approach was followed to select the value of V_{CV,ref} that partially optimizes the above mentioned criterion.

Fault in a Voltage Correcting Module

Reliability of the converter can be improved by adding redundant VCMs in each arm of the M2LC. In case of a fault in a VCM, the redundant VCM continues to operate without any interruption and the faulty VCM can be replaced at a next scheduled maintenance. It is also possible that the redundant VCMs are not added in the arms and during a fault, the M2LC reverts to a normal PWM operation, however, with increased switching frequency.

TABLE I
System parameters

| | | |
|---|---|---|
| Parameter | p.u. | SI |

| | | | | |
|---|---|---|---|---|
| Output frequency | fₒ | 1.0000 | 50 | Hz |
| Supply voltage | V_{dc} | 2.1229 | 5.2 | kV |
| Load current | iᵣ | 0.7071 | 365 | A |
| Capacitance | Cᵣₙ | 7.4539 | 5 | mF |
| VCM capacitance | C_{CM, rm} | 7.4539 | 5 | mF |
| Load resistance | Rₗ | 1.0537 | 5 | Ω |
| Arm resistance | R | 0.0211 | 100 | mΩ |
| Load inductance | Lₗ | 0.3462 | 5.23 | mH |
| Arm inductance | L | 0.0794 | 1.2 | mH |

Performance Evaluation

Viability of the proposed topology and its control was verified, using PLECS/SIMULINK simulations, for a 2MVA five level (N=4) M2LC supplying power to an inductive load, comprising a resistor and an inductor connected in series. M2LC-VCM was controlled with a Stair-Case Modulation (SCM) in conjunction with a capacitor voltage sorting algorithm, and is represented as M2LC-VCM/SCM in the following discussion. The sorting algorithm, which was based on the polarity of the arm currents, was needed to balance the capacitor voltages.

A PWM scheme with low switching frequency was also employed to control M2LC modules and is represented as M2LC-VCM/PWM. In both cases, VCMs were controlled using the coupled controller, as explained before, with a carrier frequency of 1 kHz. Performance of the M2LC-VCM was compared against an existing M2LC topology driven with a PWM scheme, where the latter is represented as M2LC/PWM. With the M2LC/PWM, frequency of the carrier waveforms, in phase disposition, was 750 Hz. Furthermore, a third harmonic was injected in the reference signals to deliver the rated power. The circuit parameters used for the simulations are summarized in Table I, using V_{B}=√(⅔)V_{II}=2449.49 V, I_{B}=√2×Iᵣₐₜ=516.19 A and f_{B}=50 Hz as base quantities in the p.u. system. Power losses, related to switching and conduction in the converter, were computed using a built-in tool of the PLECS/SIMULINK that uses performance curves, as obtained from manufacturer datasheet, for the calculations of such losses. Performance curve associated with FZ600R17KE4 and FD300R06KE3 IGBTs were used to compute the power losses in the M2LC modules and the VCMs, respectively. In Table II, the power losses are presented as a total sum of switching and conduction losses, and in case of the M2LC-VCM, these include the power losses in the VCMs.

TABLE II
Comparison of M2LC-VCM/SCM (Case1) with
M2LC-VCM/PWM (Case2) and M2LC/PWM (Case3)

| Performance indicator | Case1 | Case2 | Case3 |
|---|---|---|---|
| Power losses (kW) | 9.83 | 9.99 | 16.43 |
| Switching frequency (Hz) | 87.5 | 112.5 | 287.5 |
| THD load current (%) | 3.15 | 1.29 | 3.0 |
| Capacitor voltage variation (Vₚₖ₋ₚₖ) | 128 | 119 | 386 |
| RMS arm current (A) | 224.29 | 223.95 | 381.42 |
| RMS circulating current (A) | 6.52 | 5.27 | 306.78 |

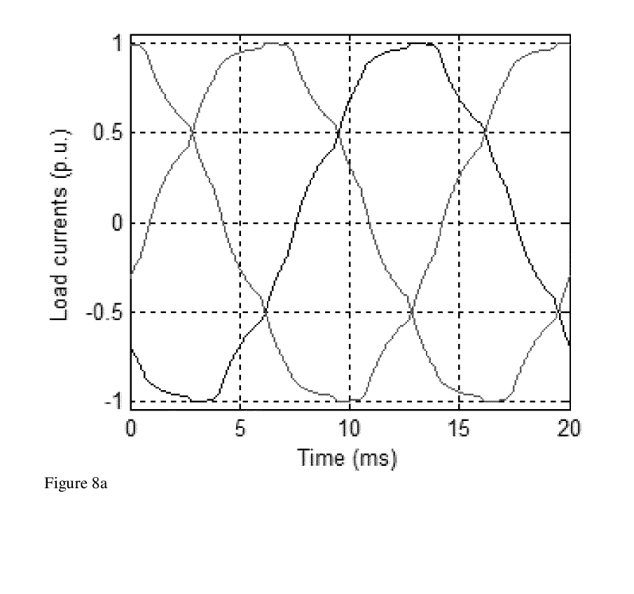

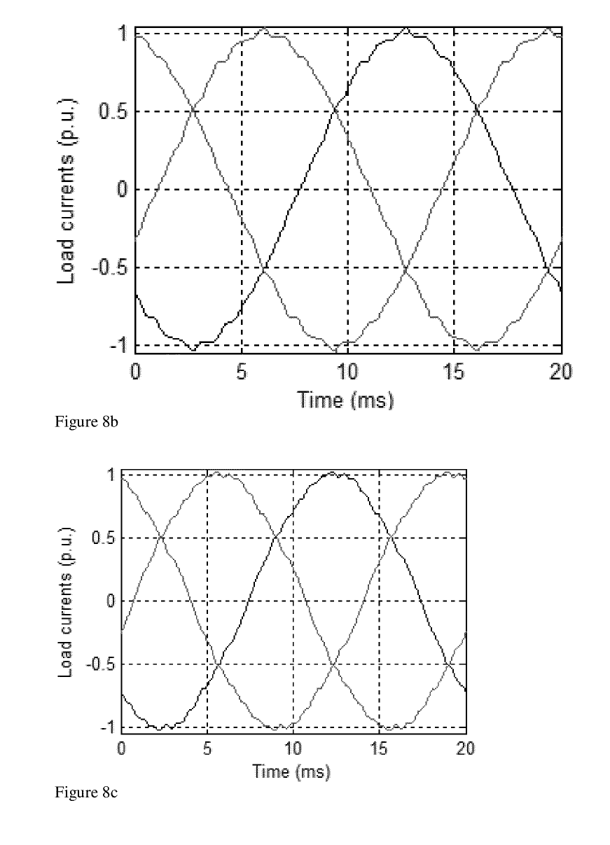

FIG. 8(a), FIG. 8(b) and FIG. 8(c) show the waveforms of the load currents with the M2LC-VCM/SCM, M2LC-VCM/PWM and M2LC/PWM, respectively. The M2LC-VCM/PWM leads to least current distortion refer Table II, at a penalty of slightly higher power losses than M2LC-VCM/SCM.

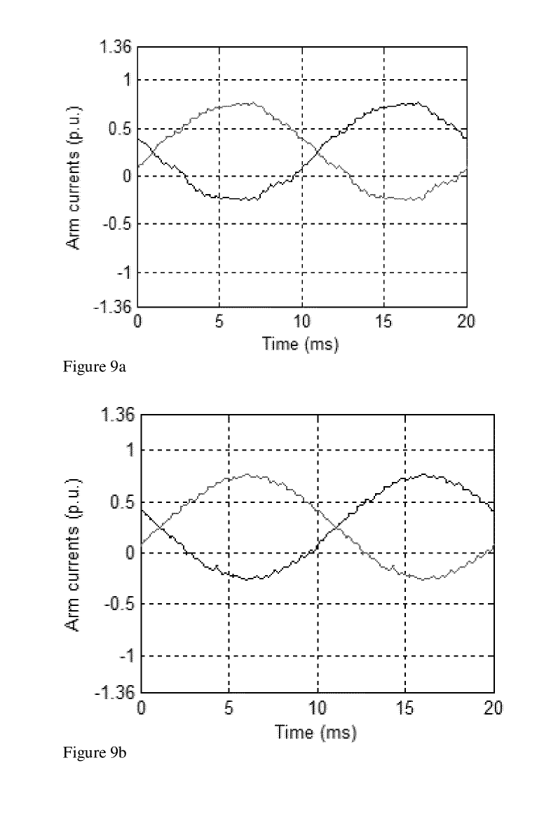

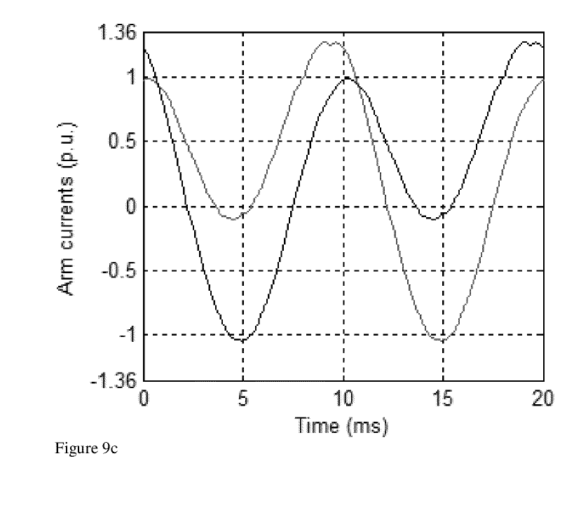

Waveforms of the arm currents in phase ‘a’with the M2LC-VCM/SCM, M2LC-VCM/PWM and M2LC/PWM are shown in FIG. 9(a), FIG. 9(b) and FIG. 9(c), respectively.

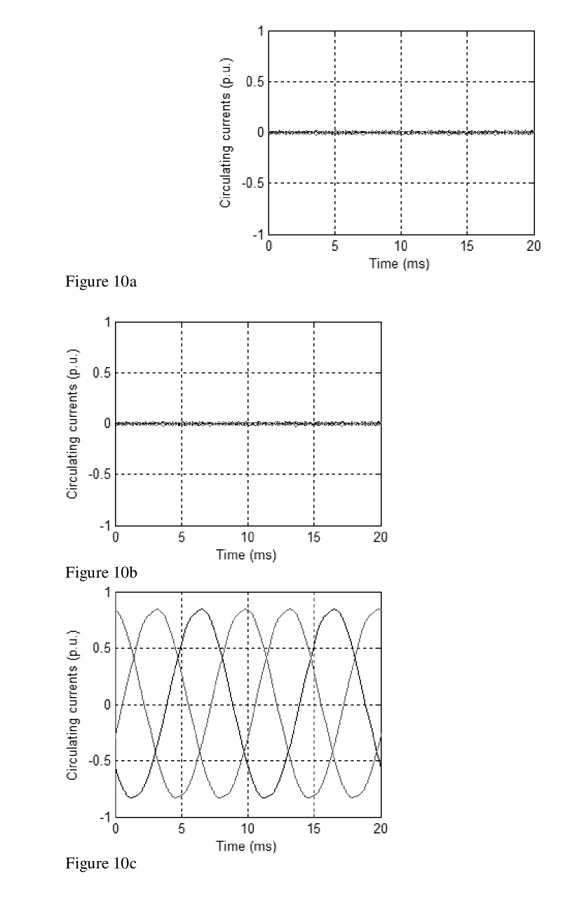

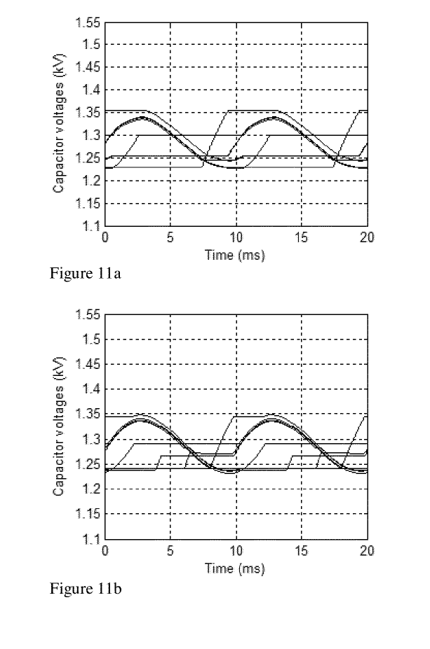

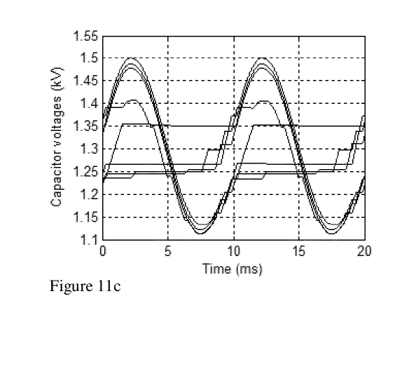

Considering arm currents with the M2LC/PWM as base quantities for the comparison, significant reductions of 41.2% and 41.29% with the M2LC-VCM/SCM and the M2LC-VCM/PWM, respectively, can be observed. Consequently, the circulating currents are significantly reduced with the proposed topology and waveforms of the circulating currents with the M2LC-VCM/SCM, M2LC-VCM/PWM and M2LC/PWM are shown in FIG. 10(a), FIG. 10(b) and FIG. 10(c), respectively.

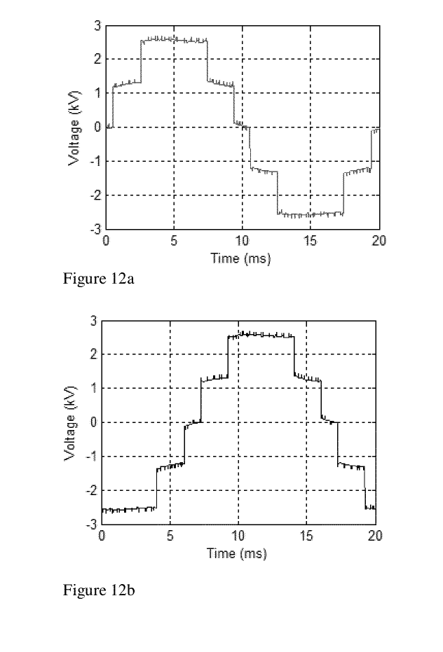

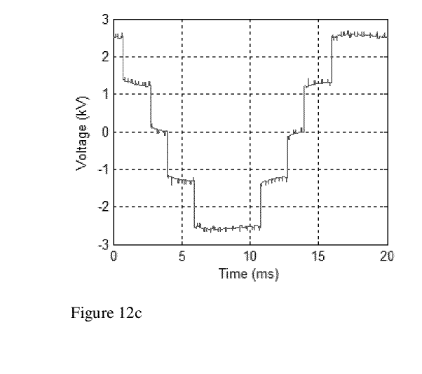

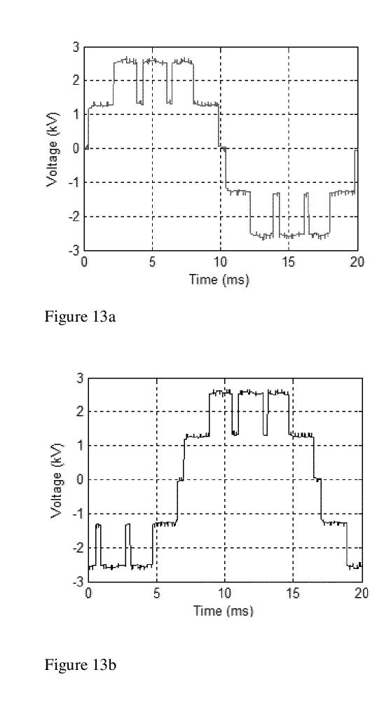

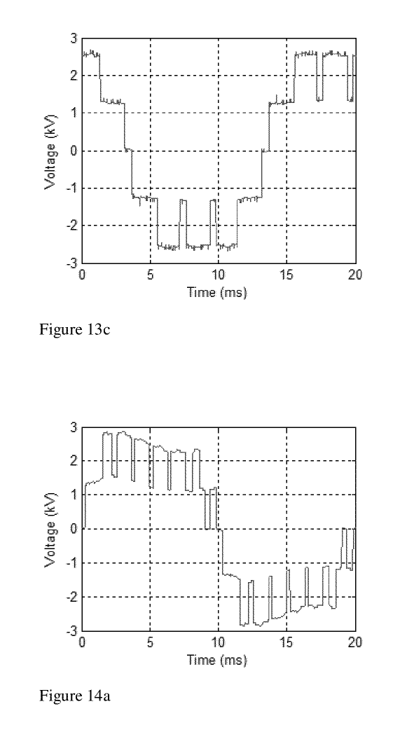

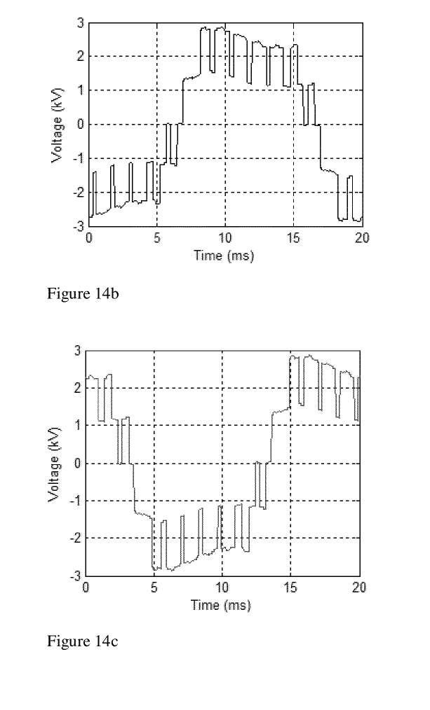

As shown in FIG. 11(a) and FIG. 11(b), variation in the capacitor voltages is controlled within 9.85% and 9.15% of the average value with the M2LC-VCM/SCM and the M2LC-VCM/PWM, respectively. M2LC/PWM does not have the capability to limit the circulating currents and consequently, the voltage variation, as shown in FIG. 11(c), is around 30% of the average value. Waveforms of the converter output voltage in phase ‘a’, associated with M2LC-VCM/SCM, M2LC-VCM/PWM and M2LC/PWM, are shown in FIG. 12, FIG. 13 and FIG. 14, respectively. It can be seen from FIG. 14 and FIG. 8 that the conventional M2LC tends to operate at a higher switching frequency when phase currents are high in comparison to significantly reduced switching frequency with the proposed topology.

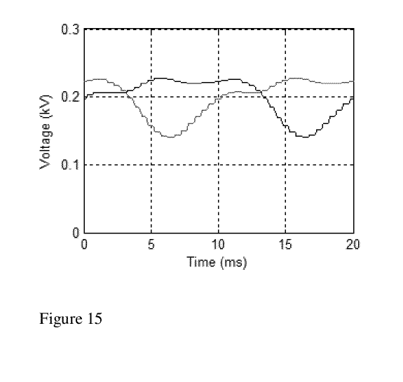

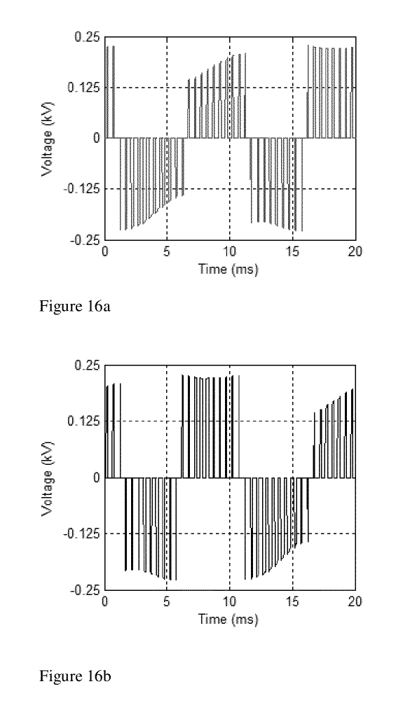

FIG. 15 shows the capacitor voltages of the VCMs in phase-leg ‘a’ and these are balanced around an average value of 200 V. The outputs of the top and bottom VCMs that are inserted as correcting voltages in phase-leg ‘a’ are shown in FIG. 16(a) and FIG. 16(b), respectively.

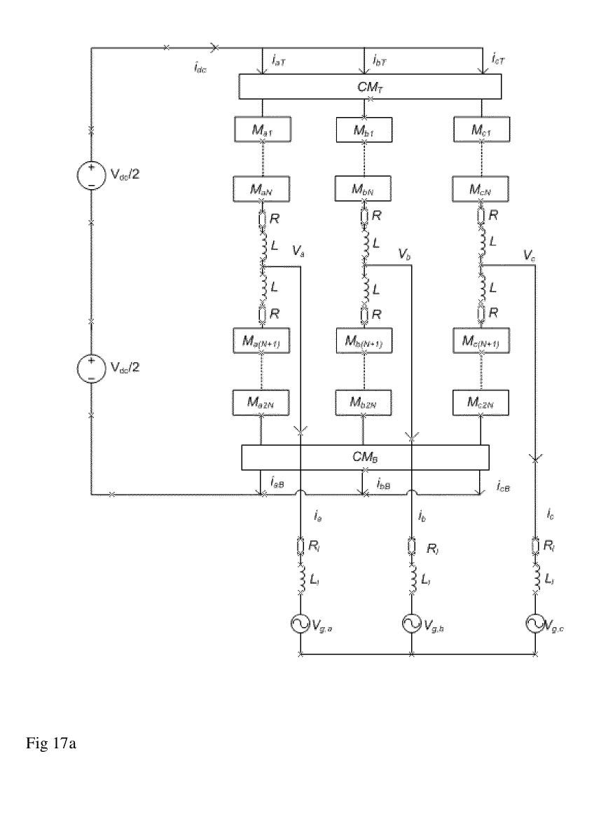

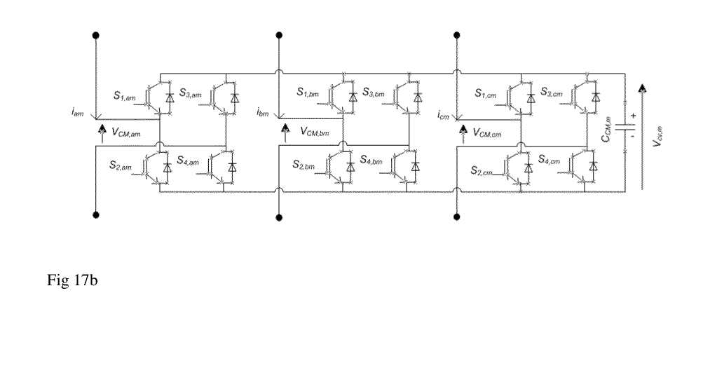

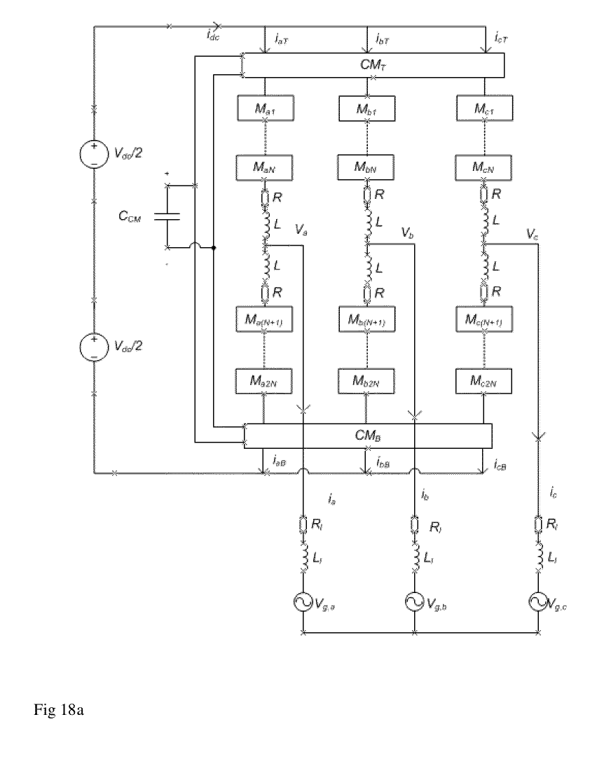

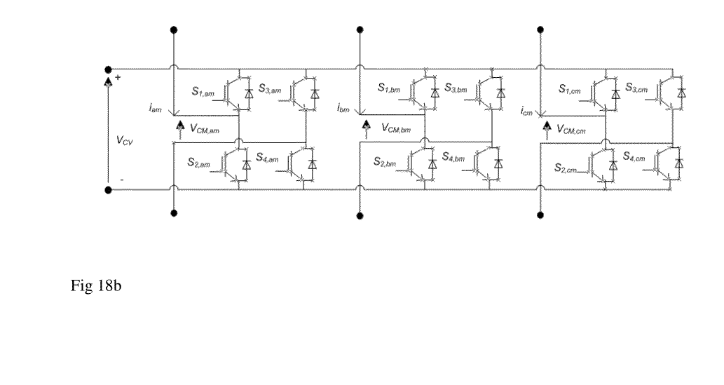

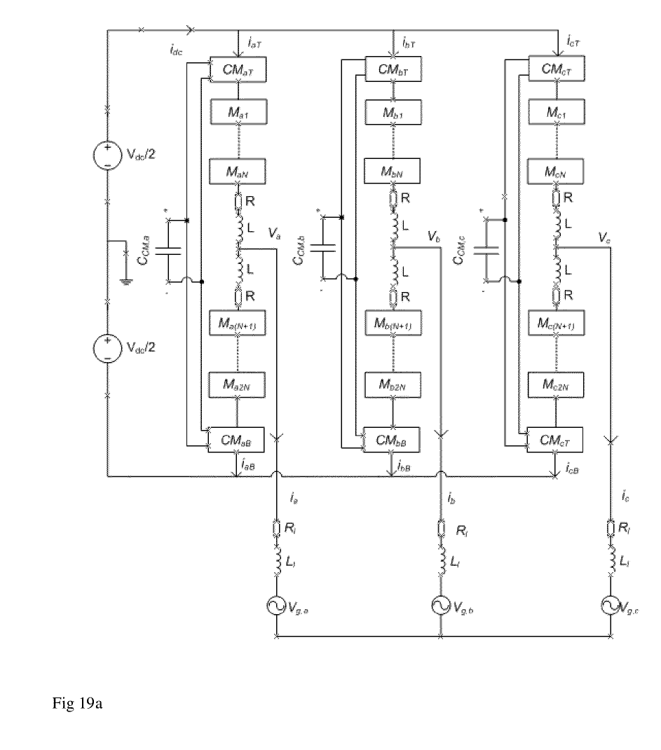

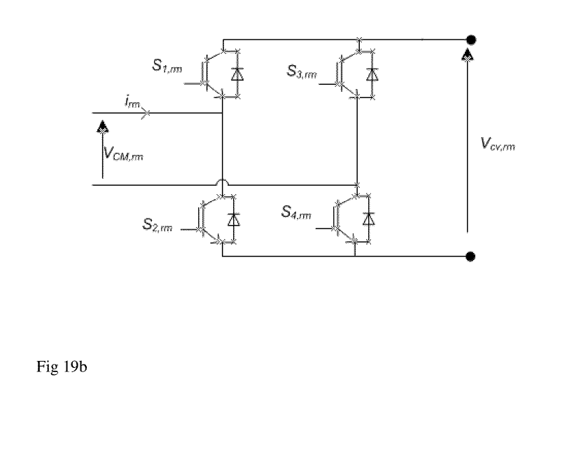

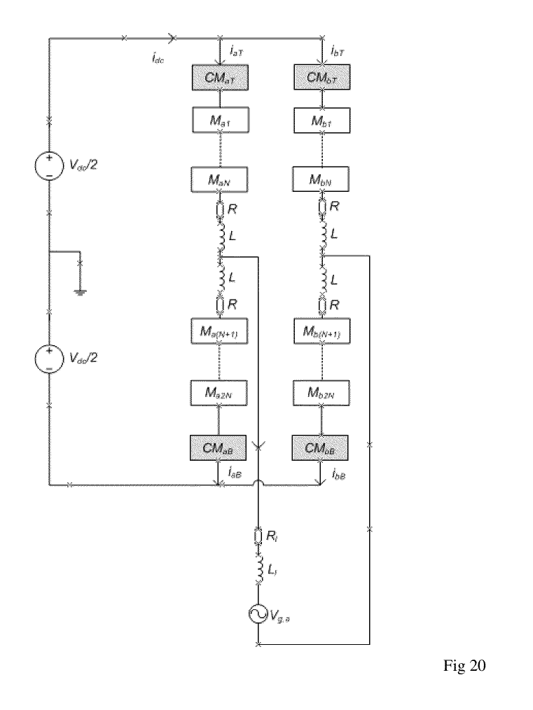

FIG. 17(a) shows an alternative of the proposed topology. In this topology, Voltage Correcting Modules in the top arms are connected to a same capacitor, C_{CM,m}, as shown in FIG. 17(b) and, similarly, Voltage Correcting Modules in the bottom arms share a capacitor. Another alternative of the proposed topology is shown in FIG. 18(a) and, in this embodiment, all Voltage Correcting Modules, as shown in FIG. 18(b), in the converter have a common capacitor. FIG. 19(a) shows yet another alternative of the proposed topology and, in this embodiment, Voltage Correcting Modules in a phase-leg, as shown in FIG. 19(b), in the converter have a common capacitor. The alternatives shown here require fewer VCM capacitors in comparison to FIG. 2(a) and, also, have an advantage related to balancing the fewer VCM capacitor voltages. FIG. 20 shows a different alternative of the proposed topology that is suitable for single phase applications. Those skilled in the art will appreciate that other alternatives may be possible.

Operation of the M2LC-VCM with the Stair-Case Modulation and the PWM (low switching frequency) has proven its benefits over the existing M2LC topology. For a given load current, M2LC-VCM/SCM yields very low power losses, however, total harmonic distortion of the load current is highest among other cases. In contrast, M2LC-VCM/PWM with slightly higher power losses than M2LC-VCM/SCM yields least THD of the load current. Moreover, variation in the capacitor voltages is smallest with the M2LC-VCM/PWM. To minimize the circulating currents and the power losses, M2LC-VCM/PWM appears to be better suited. Presently, control schemes that yield the least distortion of the load currents and switching frequency, such as selective harmonic elimination, were not employed to drive the M2LC-VCM and thus performance of the M2LC-VCM can be further improved with such schemes. Even though M2LC-VCM is not compared against, PWM based circulating current suppression schemes, it is expected that the M2LC-VCM will perform better. With such schemes and for a high modulation index, switching losses will increase, whereas, in case of the M2LC-VCM, a low switching frequency is required from the high-power modules.

Unless the context clearly requires otherwise, throughout the specification, the words “comprise”, “comprising”, and the like, are to be construed in an inclusive sense as opposed to an exclusive or exhaustive sense, that is to say, in the sense of “including, but not limited to”.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A Modular Multi-level Converter (M2LC) comprising:
a top circuit arm connected to a bottom circuit arm across a DC supply rail, each arm comprising one or more switch modules having associated capacitances and switches arranged to switch respective voltages into the arm; and
voltage correcting means (VCM) arranged to switch a correcting voltage into an arm.

2. The M2LC according to claim 1, wherein the correcting voltage is dependent on a difference between a nominal respective voltage switched in by the or each switch module and an actual voltage across the or each switch module in use.

3. The M2LC according to claim 1, wherein the VCM is controlled independently of the switch modules.

4. The M2LC according to claim 1, wherein the correcting voltage is sufficient to substantially cancel the voltage difference or circulating current.

5. The M2LC according to claim 1, wherein the voltage correcting means has an associated capacitor and switch arranged to switch the capacitance into a respective arm in order to provide the correcting voltage.

6. The M2LC according to claim 5, further comprising:
voltage or current determining means arranged to determine a voltage or current associated with the, each or a combination of switch modules;
the VCM arranged to generate a VCM reference voltage dependent on the determined voltages or currents; and
the VCM arranged to control a capacitance voltage across the capacitance associated with the VCM dependent on the VCM reference voltage.

7. The M2LC according to claim 6, wherein the VCM reference voltage is dependent on an integrated difference between a signal derived from the determined arm currents and a reference current.

8. The M2LC according to claim 6, wherein the VCM reference voltage is dependent on the difference between the DC rail and the determined arm voltages.

9. The M2LC according to claim 5, further comprising:
capacitance voltage determining means arranged to determine a voltage across the capacitance associated with the VCM; and
the VCM arranged to control the capacitance voltage dependent on a difference between the determined capacitance voltage and a reference capacitance voltage.

10. The M2LC according claim 1, and comprising three phase legs each including a top and a bottom circuit arm, each arm having a VCM.

11. The M2LC according to claim 10, wherein the capacitor associated with a VCM may be shared with one of more other VCM.

12. The M2LC according to claim 1, wherein the VCM comprises:
first and second switch pairs each having a top and a bottom switch with a common connection connected to the circuit arm such that the VCM is connected into the arm in series;
the other sides of the switches being connected across the associated capacitor; and
the switches controlled in order to generate the correcting voltage.

13. A voltage correcting means (VCM) for use in a Modular Multi-level Converter (M2LC) having a top circuit arm connected to a bottom circuit arm across a DC supply rail, each arm comprising one or more switch modules having associated capacitances and switches arranged to switch respective voltages into the arm; the VCM arranged to switch a correcting voltage into an arm.

14. The VCM according to claim 13, wherein the correction voltage is arranged to correct for a voltage difference between a nominal respective voltage switched in by the or each switch module and an actual respective voltage switched in by the or each switch module in use.

15. A method of operating a Modular Multi-level Converter (M2LC) having a top circuit arm connected to a bottom circuit arm across a DC supply rail, each arm comprising one or more switch modules having associated capacitances and switches arranged to switch respective voltages into the arm; the method comprising:
switching a correcting voltage into an arm in order to correct the or each respective voltage switched in by the switch modules.

16. The method according to claim 15, wherein the correction voltage is dependent on a difference between a nominal respective voltage switched in by the or each switch module and an actual voltage across the or each switch module in use.
